(19) United States
(12) Patent Application Publication
(10) Pub. No.: US 2009/0295269 A1
(43) Pub. Date: Dec. 3, 2009

(54) ELECTRON BEAM GENERATOR

(76) Inventors: Hiroshi MORITA, Mito (JP); Ryozo Takeuchi, Hitachi (JP); Toshiyuki Yokosuka, Hitachinaka (JP)

Correspondence Address: MCDERMOTT WILL & EMERY LLP, 600 13TH STREET, N.W., WASHINGTON, DC, 20005-3096, US

(21) Appl. No.: 12/473,507

(22) Filed: May 28, 2009

(30) Foreign Application Priority Data
May 28, 2008 (JP) 2008-138875

(51) Int. Cl. H01J 29/46

(52) U.S. Cl. 313/446

(57) ABSTRACT

An insulator of an electron beam generator is placed in vacuum, and will be electrically charged upon bombardment of electrons on the surface thereof, whereby a high electrical field is generated. In addition, when fine impurity particles are present on the surface of the insulator, such fine particles will move due to electrostatic force. These could be a cause of electrical discharge, resulting in an unstable accelerating voltage of an electron beam. An electron beam generator is provided in which an electron beam is generated from a cathode upon application of a voltage across the cathode and an anode. An insulator placed in vacuum has a ceramic substrate and a low-resistivity film formed on the surface of the substrate. The electrical volume resistivity of the low-resistivity film is less than or equal to one-hundredth of that of the substrate (see FIG. 2).

### BACKGROUND OF THE INVENTION

1. Field of the Invention

The present invention relates to an insulator that prevents electrical discharge in an electron beam generator and that stabilizes an applied voltage.

2. Background Art

In electron beam generators such as transmission electron microscopes, electrons emitted from a cathode in vacuum are accelerated with an accelerating tube before being used. In the accelerating tube, a high voltage is applied in order to accelerate electrons. However, there is a possibility that electrical discharge could be generated in vacuum due to such high voltage application.

WO 2003/107383 (Patent Document 1) discloses an electron microscope in which a ceramic with lowered resistivity is used as an insulator. It is considered that in such invention, electrical discharge can be suppressed because the resistivity is lowered by the use of a ceramic obtained by, for example, mixing titanium oxide into alumina and sintering the mixture.

Patent Document 1: WO 2003/107383

### SUMMARY OF THE INVENTION

In an electron beam generator, an insulator placed in vacuum will be electrically charged upon bombardment of electrons on the surface thereof, whereby a high electrical field is generated. In addition, when fine impurity particles are present on the surface of the insulator, such fine particles will move due to electrostatic force. These could be a cause of generation of electrical discharge, resulting in an unstable accelerating voltage of an electron beam.

However, a ceramic formed by the mixture as described in Patent Document 1 has a problem of high cost. Accordingly, it is an object of the present invention to provide an electron beam generator in which generation of electrical discharge is suppressed without the high cost.

In order to solve the aforementioned problems, the present invention takes the following measures.

One feature of the present invention is an electron beam generator in which an electron beam is generated from a cathode upon application of a voltage across the cathode and an anode, the cathode or the anode is coupled to a housing with an insulator interposed therebetween, the insulator has a substrate and a low-resistivity film formed on the surface of the substrate, and the electrical volume resistivity of the low-resistivity film is less than or equal to one-hundredth of that of the substrate. The insulator insulates a high-voltage section and the housing from each other. The housing is supplied with the ground potential (or a constant potential). For safety purposes, the housing is desirably set at the ground potential.

By the aforementioned means, the resistivity of the insulator surface can be made lower than that of the substrate. Thus, a potential rise that could occur due to electrical charging can be lessened. In addition, with a reduction of electrostatic force by the lessening of an electrical field around fine impurity particles, it becomes possible to suppress separation of the fine impurity particles off from the insulator surface. Thus, electrical discharge between the cathode and the anode can be suppressed. Further, conventionally used insulators can be used as an insulator to serve as a substrate, whereby cost increase can be avoided.

The substrate is preferably a ceramic containing greater than or equal to 90% of sintered alumina. By the use of such a ceramic containing greater than or equal to 90% of sintered alumina, which is commonly distributed and has high workability, cost reduction can be achieved.

Another feature of the present invention is an electron beam generator in which an electron beam is generated from a cathode upon application of a voltage across the cathode and an anode, the cathode or the anode is coupled to a housing with an insulator interposed therebetween, and the insulator is a ceramic containing sintered inorganic particles and having a surface with irregularities of 1 to 10 μm. When irregularities are provided on the surface of the insulator made of a ceramic so as to trap electrons that have been accelerated with an electrical field on the surface of the insulator, it becomes be possible to suppress generation of electron avalanche, which will be described later, and to suppress electrical discharge between the cathode and the anode.

Alternatively, for example, a ceramic containing sintered inorganic particles and having a surface to which inorganic particles with a diameter of 1 to 10 μm are bonded is used as the insulator. In that case, since irregularities are formed by bonding inorganic particles to the surface, an advantage is provided in that the size of the irregularities can be controlled with the size of the particles.

The electron beam generator includes an electrode that accelerates or decelerates an electron beam generated with a voltage applied. Such an electrode is coupled to the housing or to another electrode to which a different voltage is applied, with an insulator interposed therebetween. The insulator has a substrate and a low-resistivity film formed on the surface of the substrate, and the electrical volume resistivity of the low-resistivity film is less than or equal to one-hundredth of that of the substrate. With such a structure, the resistivity of the insulator surface can be made lower than that of the substrate. Thus, a potential rise that could occur due to electrical charging can be lessened. In addition, with a reduction of electrostatic force by the lessening of an electrical field around fine impurity particles, it becomes possible to suppress separation of the fine impurity particles off from the insulator surface. As a result, electrical discharge between the acceleration electrodes or the deceleration electrodes or between the electrode and the housing can be suppressed. Further, conventionally used insulators can be used as an insulator to serve as a substrate, whereby cost increase can be avoided.

Yet another feature of the present invention is an electron beam generator in which an electron beam is generated from a cathode upon application of a voltage across the cathode and an anode. The electron beam generator includes acceleration electrodes that accelerate or decelerate an emitted electron beam. The plurality of such acceleration electrodes are arranged with insulators interposed therebetween, and at least part of the acceleration electrodes is connected to the housing with the insulator interposed therebetween. There are cases in which electrical discharge is generated between the acceleration electrodes or between the acceleration electrode and the housing. Thus, a ceramic containing sintered inorganic particles and having a surface with irregularities of 1 to 10 μm is used as the insulator. By trapping electrons that have been accelerated with an electrical field on the surface of the insulator, it is possible to suppress generation of electron avalanche and to suppress electrical discharge between the acceleration electrodes or the deceleration electrodes or between the electrode and the housing.

In addition to the insulator made of a ceramic formed using inorganic particles and having a surface with irregularities of 1 to 10 μm, it is also possible to use an insulating material obtained by bonding inorganic particles with a diameter of 1 to 10 μm to a ceramic substrate containing sintered inorganic particles. According to such means, irregularities are provided on the surface of the insulator so that electrical discharge between the acceleration electrodes or the deceleration electrodes or between the electrode and the housing can be suppressed. Further, since irregularities are formed by bonding inorganic particles to the surface, an advantage is provided in that the size of the irregularities can be controlled with the size of the particles.

According to the present invention, the resistivity of the insulator surface can be made lower than that of the substrate in an electron beam generator. Thus, a potential rise that could occur due to electrical charging can be lessened. In addition, with a reduction of electrostatic force by the lessening of an electrical field around fine impurity particles, it becomes possible to suppress separation of the fine impurity particles off from the insulator surface. Thus, electrical discharge between the cathode and the anode can be suppressed. Further, conventionally used insulators can be used as an insulator to serve as a substrate, whereby cost increase can be avoided.

According to the present invention, an electron beam generator with a stable accelerating voltage of an electron beam can be provided at low cost.

### BRIEF DESCRIPTION OF THE DRAWINGS

FIG. 1 is a diagram illustrating the structure of a transmission electron microscope.

FIG. 2 is a diagram illustrating the structure of an electron gun for an electron microscope.

FIG. 3 is a diagram illustrating the structure of an accelerating tube for an electron microscope.

FIG. 4 is a diagram illustrating the structure of an X-ray tube.

### DESCRIPTION OF SYMBOLS

100 electron beam
101 electron gun
102 accelerating tube
103 condenser lens
104 sample
105 objective lens
106 intermediate lens
107 projector lens
108 fluorescent screen
109 observation window
110 camera chamber
111, 303 insulator
201 housing
202 heating filament
203, 402 cathode
204 extraction electrode
205 extraction electrode insulator
206 cable
207 cable head
208 current introduction terminal insulator
209 current introduction terminal
301 inner electrode
302 outer electrode
304 dividing resistor
305 acceleration power supply
306 electron beam
401 envelope
403 rotating anode
404 rotor
405 stator coil
406 tube housing

### DETAILED DESCRIPTION OF THE PREFERRED EMBODIMENTS

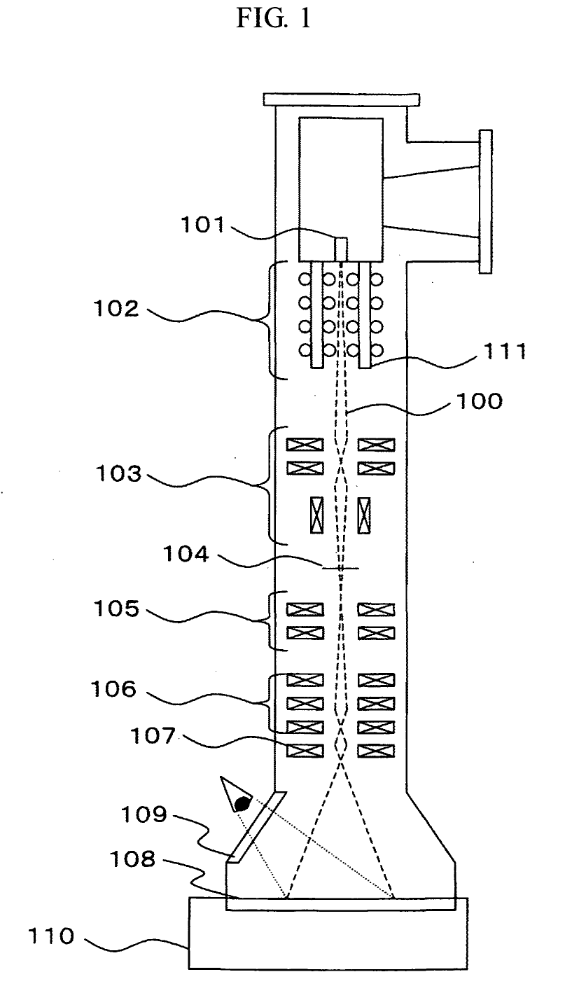

First, the structure of an electron beam generator will be described. FIG. 1 illustrates an exemplary schematic construction of a transmission electron microscope, as an example of a system having an electron beam generator. The transmission electron microscope of this example includes an electron gun, an accelerating tube, and a lens group that adjusts electron beams. An electron gun 101 generates an electron beam by accelerating at an anode electrons emitted from a cathode. Examples of the electron gun include thermionic-emission electron guns, Schottky-type electron guns, and cold field-emission guns. An accelerating tube 102 sequentially accelerates electron beams emitted from the electron gun to a required voltage level. The accelerating tube includes multiple electrodes that are connected to one another with resistors. An electrode at one end is connected to the power supply, and the potentials of the electrodes become closer to the potential of the electrode at the other end along the electrodes. The electrode at the other end is at the ground potential or a constant potential. In an electron microscope of 200 kV, for example, electrons are accelerated with six stages or seven stages of stacked acceleration electrodes.

The condenser lens 103 converges an electron beam 100 with a magnetic field generated, and irradiates a sample with the converged electron beam 100. The electron beam 100 transmitted through a sample 104 is diffracted. Diffracted electrons are focused at an objective lens 105. The focal length of an intermediate lens 106 is changed by the adjustment of an excitation current so that the intermediate lens 106 is focused on diffraction patterns formed by the objective lens. Further, the intermediate lens 106 magnifies such patterns and forms an image at the object plane of a projector lens 107. The projector lens 107 is the final lens of the imaging lens system, and it further magnifies the image that has been magnified by the intermediate lens 106 and projects it onto a fluorescent screen 108. Such an image can be observed from an observation window 109, and can also be captured with a camera provided in a camera chamber 110.

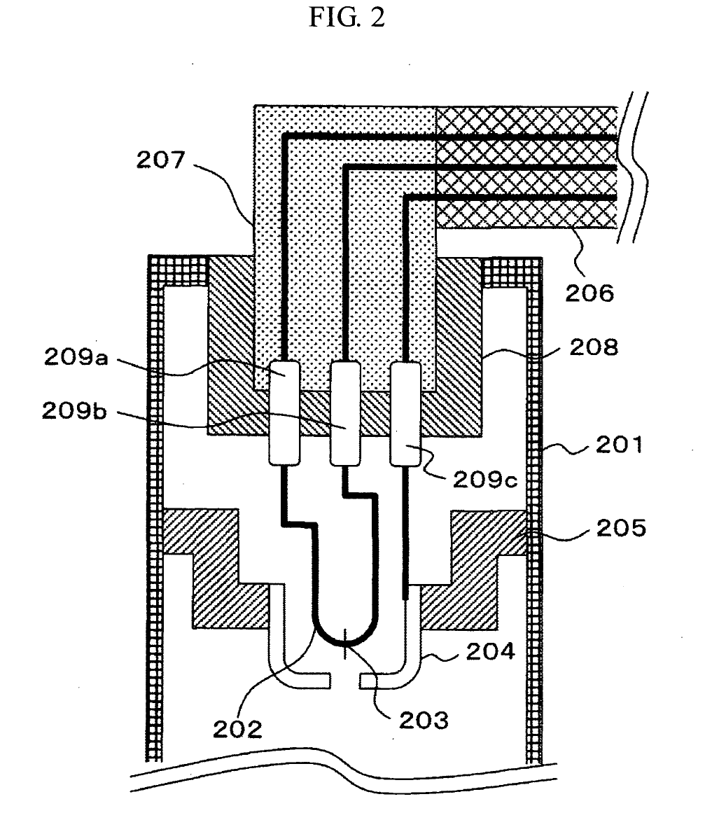

FIG. 2 illustrates a specific arrangement of the typical electron gun 101. A cathode 203 is attached to the tip of a heating filament 202. The radius of curvature of the tip of the cathode 203 is extremely small, as small as about 1000 Å. When a voltage is applied across the cathode 203 and an extraction electrode 204, a high electrical field is applied to the tip of the cathode 203. The extraction electrode 204 is fixed on a housing 201 with an extraction electrode insulator 205 interposed therebetween. Direct-current power supplies that apply voltages to the electrodes are electrically connected to current introduction terminals 209a, 209b, and 209c, respectively, that are fixed on a current introduction terminal insulator 208 with a cable 206 and a cable head 207. The heating filament 202 and the extraction electrode 204 are electrically connected to the current introduction terminals 209a, 209b, and 209c, so that a desired voltage is applied to the heating filament 202 and the extraction electrode 204. The cathode 203 to which a high electrical field is applied as described above emits electrons and thus functions as an electron source of an electron microscope.

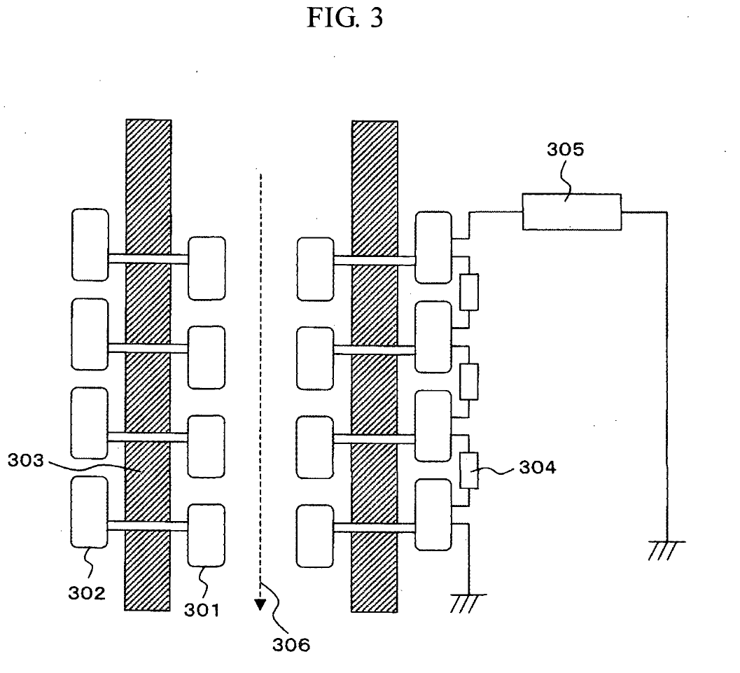

FIG. 3 illustrates an exemplary structure of an accelerating tube. The accelerating tube has a structure in which acceleration electrodes, each of which includes a ring-shaped inner electrode 301 and outer electrode 302, and insulators 303 are stacked in multiple stages. The first-stage acceleration electrode is connected to an acceleration power supply 305 and a high direct-current voltage is applied thereto. A dividing resistor 304 is connected between the adjacent acceleration electrodes, and the final-stage acceleration electrode is at the ground potential. With such arrangement of the acceleration electrodes, it becomes possible for an electrical field to be generated in the center of the ring-shaped accelerating tube in a direction perpendicular to the acceleration electrodes. At this time, a voltage of, for example, 200 kV is applied across the first-stage acceleration electrode and the final-stage acceleration electrode, which means that a voltage of several tens of kilovolts is applied across the adjacent acceleration electrodes. An electron gun is disposed at the first stage of the accelerating tube. An electron beam 306 emitted from the electron gun is accelerated by the electrical field generated in the center of the accelerating tube in the perpendicular direction.

In a transmission electron microscope, a voltage of several tens of kilovolts is applied across opposite ends of an insulator 111. In such a case, there is a possibility that electrical discharge could be generated on the surface of the insulator in vacuum. In cases of an electron source and an accelerating tube as well, a voltage of several tens of kilovolts is also applied across opposite ends of an insulator.

There are several theories about the mechanism of electrical discharge generated in vacuum. Such theories will be described below by giving the following examples: (1) due to an increase in electrical field resulting from an insulator being electrically charged and (2) due to fine impurity particles.

(1) An insulator being electrically charged results from a phenomenon that electrons emitted from a cathode, or reflected electrons or secondary electrons, which are generated by the bombardment of electrons on a sample, impinge on the surface of the insulator in vacuum. In such a case, secondary electrons are emitted from the insulator, and thus a shortage of electrons occurs on the surface of the insulator, whereby the surface is positively charged. Insulators typically have a secondary electron emission coefficient (the number of secondary electrons emitted upon electron bombardment) of greater than or equal to 1 in many cases. Therefore, the aforementioned electrical charging could cause a local potential rise on the surface of the insulator, which in turn could increase the electrical field on the surface of the insulator, and thus, electrical discharge due to electron avalanche could easily occur.

(2) According to another theory concerning fine impurity particles, when fine impurity particles that stick to the surface of an insulator are separated off from the insulator due to electrostatic force, such fine impurity particles will be accelerated by a voltage and then impinge on the electrodes, whereupon metal vapor is generated. Then, it becomes ionized plasma by the bombardment of electrons, thereby causing electrical discharge between the electrodes.

Such mechanisms of electrical discharge are detailed in “Electrical Discharge Handbook” (edited by the Institute of Electrical Engineers of Japan).

Each of the aforementioned electrical discharge can be suppressed by lowering the resistivity of the insulator and thus lessening a potential rise that could occur due to electrical charging. In addition, when electrostatic force is reduced by the lessening of an electrical field around fine impurity particles, separation of the fine impurity particles off from the surface of the insulator can be expected to be suppressed.

Hereinafter, specific description will be given by way of embodiments.

### Embodiment 1

The first embodiment illustrates an example in which an insulator surface according to one aspect of the present invention is applied to an electron gun of an electron microscope. The overall structure of the electron gun is the same as that in FIG. 2. The cathode 203 is attached to the tip of the heating filament 202. The cathode is preferably made of tungsten, lanthanum hexaboride, carbon nanotube, or the like. The radius of curvature of the tip of the cathode 203 is extremely small. When the cathode 203 is made of tungsten or lanthanum hexaboride, it is about 1000 Å long, and when made of carbon nanotube, it is about 10 Å long. When a voltage is applied across the cathode 203 and the extraction electrode 204, a high electrical field is applied to the tip of the cathode 203. The extraction electrode 204 is fixed on the housing 201 with the extraction electrode insulator 205 interposed therebetween. Direct-current power supplies that apply voltages to the electrodes are electrically connected to the current introduction terminals 209a, 209b, and 209c, respectively, that are fixed on the current introduction terminal insulator 208 with the cable 206 and the cable head 207. The heating filament 202 and the extraction electrode 204 are electrically connected to the current introduction terminals 209a, 209b, and 209c, so that a desired voltage is applied to the heating filament 202 and the extraction electrode 204. The cathode 203 to which a high electrical field is applied as described above emits electrons and thus functions as an electron source of an electron microscope.

Each of the extraction electrode insulator 205 and the current introduction terminal insulator 208 has a substrate and a low-resistivity film formed on the surface thereof, the low-resistivity film having an electrical volume resistivity of less than or equal to one-hundredth of that of the substrate. The substrate is desirably made of a ceramic containing greater than or equal to 90% of sintered alumina. Alternatively, other ceramics such as sapphire, mullite, cordierite, steatite, forsterite, yttria, titania, silicon nitride, aluminum nitride, or zirconia can also be used. The low-resistivity film is preferably made of a material including indium tin oxide, zinc oxide, titanium oxide, tin oxide, boron oxide, lead oxide, or the like. The low-resistivity film may be closely attached to the entire surface of the substrate in a continuous manner or be closely attached to parts of the surface of the substrate in island shapes.

Each of the extraction electrode insulator 205 and the current introduction terminal insulator 208 is an insulator having a surface provided with irregularities of 1 to 10 μm. When a test was conducted in which ceramic was replaced by glass and irregularities were provided on the surface, the effect of reducing the discharge voltage was obtained by providing irregularities of 1 to 10 μm on the glass that has irregularities of less than or equal to 1 μm. The method of providing irregularities on the surface of the substrate is preferably sandblasting. The insulator is preferably made of a ceramic containing greater than or equal to 90% of sintered alumina. Alternatively, other ceramics such as sapphire, mullite, cordierite, steatite, forsterite, yttria, titania, silicon nitride, aluminum nitride, or zirconia can also be used.

As an alternative method of providing irregularities on the insulator, it is also possible to bond inorganic particles with a diameter of 1 to 10 μm to the surface of the substrate. Inorganic particles used are preferably alumina, silica, sapphire, mullite, cordierite, steatite, forsterite, yttria, titania, silicon nitride, aluminum nitride, zirconia, or the like. Among methods of bonding inorganic particles is a method which includes the steps of spraying a liquid containing a mixture of the aforementioned inorganic particles, low-melting-point glass powder, and a solvent onto an insulator, and heating it up to the melting point of the glass powder or higher so that the glass powder is melted and the inorganic particles and the insulator are bonded to each other.

With the aforementioned structure, the resistivity of the insulator surface can be lowered, and thus a potential rise that could occur due to electrical charging can be expected to be lessened. In addition, with a reduction of electrostatic force by the lessening of an electrical field around fine impurity particles, separation of the fine impurity particles off from the insulator surface can be expected to be suppressed. Thus, electrical discharge on the insulator surface can be suppressed.

As a result of the electrical discharge test of the insulators in this embodiment, it was found that the discharge voltage can be expected to be improved about 1.5 times higher than a case in which no irregularities are provided.

### Embodiment 2

The second embodiment illustrates an example in which an insulator surface according to one aspect of the present invention is applied to an accelerating tube of an electron microscope. FIG. 3 illustrates an exemplary structure of the accelerating tube.

The accelerating tube has a structure in which acceleration electrodes, each of which includes the ring-shaped inner electrode 301 and outer electrode 302, and the insulators 303 are stacked in multiple stages. The first-stage acceleration electrode is connected to the acceleration power supply 305 and a high direct-current voltage is applied thereto. The dividing resistor 304 is connected between the adjacent acceleration electrodes, and the final-stage acceleration electrode is at the ground potential. With such arrangement of the acceleration electrodes, it becomes possible for an electrical field to be generated in the center of the ring-shaped accelerating tube in a direction perpendicular to the acceleration electrodes. At this time, a voltage of, for example, 200 kV is applied across the first-stage acceleration electrode and the final-stage acceleration electrode, which means that a voltage of several tens of kilovolts is applied across the adjacent acceleration electrodes. An electron gun is disposed at the first-stage of the accelerating tube. An electron beam 306 emitted from the electron gun is accelerated by the electrical field generated in the center of the accelerating tube in the perpendicular direction.

The insulator 303 has a substrate and a low-resistivity film formed on the surface of the substrate. The electrical volume resistivity of the low-resistivity film is less than or equal to one-hundredth of that of the substrate.

The substrate is desirably made of a ceramic containing greater than or equal to 90% of sintered alumina. Alternatively, other ceramics such as sapphire, mullite, cordierite, steatite, forsterite, yttria, titania, silicon nitride, aluminum nitride, or zirconia can also be used. The low-resistivity film is preferably made of a material including indium tin oxide, zinc oxide, titanium oxide, tin oxide, boron oxide, lead oxide, or the like. The low-resistivity film can be closely attached to the entire surface of the substrate in a continuous manner or be closely attached to parts of the surface of the substrate in island shapes.

The insulator 303 may have a surface with irregularities of 1 to 10 μm. The method of providing irregularities on the surface is preferably sandblasting. The insulator is desirably made of a ceramic containing greater than or equal to 90% of sintered alumina. Alternatively, other ceramics such as sapphire, mullite, cordierite, steatite, forsterite, yttria, titania, silicon nitride, aluminum nitride, or zirconia can also be used.

As an alternative method of providing irregularities on the insulator 303, it is also possible to bond inorganic particles with a diameter of 1 to 10 μm to the surface. Inorganic particles used are preferably alumina, silica, sapphire, mullite, cordierite, steatite, forsterite, yttria, titania, silicon nitride, aluminum nitride, zirconia, or the like. Among methods of bonding inorganic particles is a method which includes the steps of spraying a liquid containing a mixture of the aforementioned inorganic particles, low-melting-point glass powder, and a solvent onto an insulator, and heating it up to the melting point of the glass powder or higher so that the glass powder is melted and the inorganic particles and the insulator are bonded to each other.

With the aforementioned structure, the resistivity of the insulator surface can be lowered, and thus a potential rise that could occur due to electrical charging can be expected to be lessened. In addition, with a reduction of electrostatic force by the lessening of an electrical field around fine impurity particles, separation of the fine impurity particles off from the insulator surface can be expected to be suppressed. Thus, electrical discharge on the insulator surface can be suppressed.

Further, the dividing resistor 304 is provided in the accelerating tube as illustrated in FIG. 3 in order to supply a predetermined potential to each electrode. By the addition of a low-resistivity film to the insulator of the accelerating tube, the insulator itself can function as a dividing resistor. Thus, it is necessary to take into account the resistance of such an insulator in designing the resistance value of the dividing resistors. In addition, when the resistance value of the insulator coincides with the designed resistance value, the dividing resistors can be omitted.

### Embodiment 3

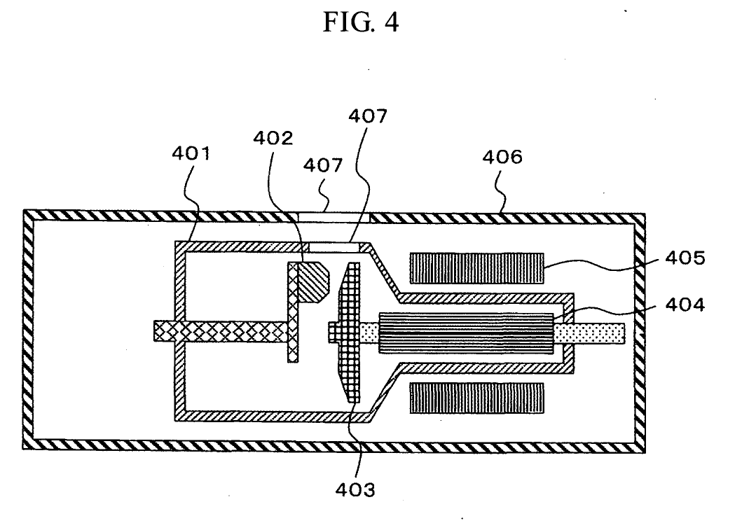

The third embodiment illustrates an example in which an insulator surface according to one aspect of the present invention is applied to an X-ray tube. FIG. 4 illustrates an exemplary structure of a prior-art rotating-anode X-ray tube. A tube housing 406 is a metal housing, and a lead plate is provided on the inner surface thereof in order to shield against unwanted X rays upon generation of X rays. In the housing, an envelope 401 and a stator coil 405 for rotating a rotating anode 403 within the envelope 401 are disposed. Each of the envelope 401 and the stator coil 405 is supported by the tube housing 406 with a support made of an insulator therebetween.

A cathode 402 and the rotating anode 403 arranged opposite the cathode 402 are disposed in the envelope 401 maintained in vacuum. The envelope 401 is made of an insulator or a combination of an insulator and a metal. The cathode 402 has a filament that emits thermoelectrons and is connected to a heating transformer. The rotating anode 403 is connected to a rotor 404. The rotating anode 403 has a target that generates X rays upon bombardment of an electron beam thereon from the cathode 402. The target is made of a metal whose melting point and atomic number are high, such as tungsten. The cathode 402 is connected to a negative electrode terminal of a high-voltage generator, while the rotating anode 403 is connected to a positive electrode terminal of the high-voltage generator. While the X-ray tube is in use or in operation, a magnetic field generated by the stator coil 405 causes the rotor 404 to rotate, which in turn rotates the rotating anode 403 connected thereto. At this time, the high-voltage generator applies a voltage as high as 100 kV or higher across the rotating anode 403 and the cathode 402 of the X-ray generator. At the same time, the filament of the cathode 402 is heated by the heating transformer. Thus, thermoelectrons emitted from the filament of the cathode 402 are accelerated by the high voltage, and impinge on the focal spot of the target of the rotating anode 403, thereby generating an X ray. The generated X ray is allowed to be radiated through a window 407 made of beryllium or the like.

The insulator of the envelope 401 has a substrate and a low-resistivity film formed on the surface thereof, the low-resistivity film having an electrical volume resistivity of less than or equal to one-hundredth of that of the substrate. The substrate is desirably made of a ceramic containing greater than or equal to 90% of sintered alumina. Alternatively, other ceramics such as sapphire, mullite, cordierite, steatite, forsterite, yttria, titania, silicon nitride, aluminum nitride, or zirconia can also be used. The low-resistivity film is preferably made of a material including indium tin oxide, zinc oxide, titanium oxide, tin oxide, boron oxide, lead oxide, or the like. The low-resistivity film can be closely attached to the entire surface of the substrate in a continuous manner or be closely attached to parts of the surface of the substrate in island shapes.

The insulator of the envelope 401 may have a surface with irregularities of 1 to 10 μm. The method of providing irregularities on the surface is preferably sandblasting. The insulator is desirably made of a ceramic containing greater than or equal to 90% of sintered alumina. Alternatively, other ceramics such as sapphire, mullite, cordierite, steatite, forsterite, yttria, titania, silicon nitride, aluminum nitride, or zirconia can also be used.

As an alternative method of providing irregularities on the insulator of the envelope 401, it is also possible to bond inorganic particles with a diameter of 1 to 10 μm to the surface. Inorganic particles used are preferably alumina, silica, sapphire, mullite, cordierite, steatite, forsterite, yttria, titania, silicon nitride, aluminum nitride, zirconia, or the like. Among methods of bonding inorganic particles is a method which includes the steps of spraying a liquid containing a mixture of the aforementioned inorganic particles, low-melting-point glass powder, and a solvent onto an insulator, and heating it up to the melting point of the glass powder or higher so that the glass powder is melted and the inorganic particles and the insulator are bonded to each other.

With the aforementioned structure, the resistivity of the insulator surface can be lowered, and thus a potential rise that could occur due to electrical charging can be expected to be lessened. In addition, with a reduction of electrostatic force by the lessening of an electrical field around fine impurity particles, separation of the fine impurity particles off from the insulator surface can be expected to be suppressed. Thus, electrical discharge on the insulator surface can be suppressed.

Although the rotating-anode X-ray tube has been described above, there is also a stationary anode X-ray tube whose anode does not rotate. The method of generating X-rays with the stationary-anode type is the same as that with the rotating-anode type. In the stationary-anode type, the rotor 404 and the stator coil 405 that would be required to rotate the anode are not necessary because the anode does not rotate. However, the structure and the surface shape of an insulator are the same as those of the rotating-anode type. Thus, the method can be advantageously applied to such a product as well.

What is claimed is:

1. An electron beam generator comprising:
a cathode;
an anode;
a housing with a vacuum interior; and
an insulator adapted to fix the cathode and the anode on the housing,
wherein:
an electron beam is generated from the cathode upon application of a voltage across the cathode and the anode,
the insulator includes a substrate and a low-resistivity film formed on a surface of the substrate, and
the electrical volume resistivity of the low-resistivity film is less than or equal to one-hundredth of that of the substrate.

2. The electron beam generator according to claim 1, wherein the substrate is a ceramic containing greater than or equal to 90% of sintered alumina.

3. An electron beam generator comprising:
a cathode;
an anode;
a housing with a vacuum interior; and
an insulator adapted to fix the cathode and the anode on the housing,
wherein:
an electron beam is generated from the cathode upon application of a voltage across the cathode and the anode,
the insulator includes a substrate and an irregular layer formed on a surface of the substrate, the irregular layer having a height of 1 to 10 μm, and
the insulator is a ceramic containing sintered inorganic particles.

4. The electron beam generator according to claim 3, wherein the substrate is a ceramic containing greater than or equal to 90% of sintered alumina.

5. The electron beam generator according to claim 3, wherein the irregular layer is a sintered ceramic layer to which inorganic particles with a diameter of 1 to 10 μm are bonded.

6. An electron beam generator comprising:
a cathode;
an anode;
a housing with a vacuum interior, in which an electron beam is generated from the cathode upon application of a voltage across the cathode and the anode; and
an acceleration electrode that accelerates or decelerates the generated electron beam with a voltage applied,
wherein:
the acceleration electrode is coupled to the housing or to another electrode to which a different voltage is applied, with an insulator interposed therebetween,
the insulator includes a substrate and a low-resistivity film formed on a surface of the substrate, and
the electrical volume resistivity of the low-resistivity film is less than or equal to one-hundredth of that of the substrate.

7. The electron beam generator according to claim 6, wherein the substrate is a ceramic containing greater than or equal to 90% of sintered alumina.

8. An electron beam generator comprising:
a cathode;
an anode;
a housing with a vacuum interior, in which an electron beam is generated from the cathode upon application of a voltage across the cathode and the anode; and
an acceleration electrode that accelerates or decelerates the generated electron beam with a voltage applied,
wherein:
the acceleration electrode is coupled to the housing or to another electrode to which a different voltage is applied, with an insulator interposed therebetween,
the insulator includes a substrate and an irregular layer formed on a surface of the substrate, the irregular layer having a height of 1 to 10 μm, and
the insulator is a ceramic containing sintered inorganic particles.

9. The electron beam generator according to claim 8, wherein the substrate is a ceramic containing greater than or equal to 90% of sintered alumina.

10. The electron beam generator according to claim 8, wherein the irregular layer is a sintered ceramic layer to which inorganic particles with a diameter of 1 to 10 μm are bonded.
